(19) United States
(12) Patent Application Publication
(10) Pub. No.: US 2024/0386427 A1
(43) Pub. Date: Nov. 21, 2024

(54) METHOD AND SYSTEM FOR TRIGGERING EXECUTION OF A SMART CONTRACT

(71) Applicant: The Toronto-Dominion Bank, Toronto (CA)

(72) Inventors: Mohamed ABBAS, Jersey City, NJ (US); Levi SUTTER, Westampton, NJ (US); Lina Nancy SICILIANO, Voorhees, NJ (US); Marcus Edward FURLONG, Sandy Springs, GA (US); Alisha ROMER, Blackwood, NJ (US)

(73) Assignee: The Toronto-Dominion Bank, Toronto, ON (CA)

(21) Appl. No.: 18/320,300

(22) Filed: May 19, 2023

(51) Int. Cl. G06Q 20/40; G06Q 20/02; G06Q 20/32

(52) U.S. Cl. CPC G06Q 20/40145; G06Q 20/02; G06Q 20/3226

(57) ABSTRACT

A system comprises a communications module; at least one processor coupled to the communications module; and a memory coupled to the at least one processor, the memory storing processor-executable instructions which, when executed by the at least one processor, configure the at least one processor to generate a smart contract that includes at least one precondition associated with voice input; deploy the smart contract on a blockchain network; obtain the voice input; and communicate an indication of the voice input to the blockchain network to automatically trigger execution of the smart contract.

### TECHNICAL FIELD

The present application relates to methods and systems for triggering execution of a smart contract.

### BACKGROUND

Smart contracts are computer programs that are stored on a blockchain network. Smart contracts automatically execute when predetermined conditions are met. A network of computers may execute the actions when the predetermined conditions have been met and verified. The blockchain network may be updated when execution of the smart contract is complete.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a diagram illustrating an example blockchain network of an example embodiment;

FIG. 3 is a simplified schematic diagram showing components of a computing device of an example embodiment;

FIG. 4 is a high-level schematic diagram of an example computer device;

FIG. 5 shows a simplified organization of software components stored in a memory of the example computer device of FIG. 4; and

FIG. 6 is a flowchart showing operations performed by a server in triggering execution of a smart contract according to an embodiment.

Like reference numerals are used in the drawings to denote like elements and features.

### DETAILED DESCRIPTION OF VARIOUS EMBODIMENTS

Accordingly, in one aspect there is provided a system comprising a communications module; at least one processor coupled to the communications module; and a memory coupled to the at least one processor, the memory storing processor-executable instructions which, when executed by the at least one processor, configure the at least one processor to generate a smart contract that includes at least one precondition associated with voice input; deploy the smart contract on a blockchain network; obtain the voice input; and communicate an indication of the voice input to the blockchain network to automatically trigger execution of the smart contract.

In one or more embodiments, prior to communicating the indication of the voice input to the blockchain network, the processor-executable instructions, when executed by the at least one processor, configure the at least one processor to engage a voice recognition module to analyze the voice input to authenticate a user.

In one or more embodiments, when analyzing the voice input to authenticate the user, the processor-executable instructions, when executed by the at least one processor, configure the at least one processor to retrieve, from a database, a voiceprint of the user; and compare acoustic properties of the voice input to the voiceprint of the user to authenticate the user.

In one or more embodiments, prior to communicating the indication of the voice input to the blockchain network, the processor-executable instructions, when executed by the at least one processor, configure the at least one processor to engage a natural language processing module to convert the voice input to text; and analyze the text to confirm that the at least one precondition has been met.

In one or more embodiments, the at least one precondition requires voice input from a particular user.

In one or more embodiments, the at least one precondition requires at least one audio file of the voice input and a voice to text translation of the voice input.

In one or more embodiments, the execution of the smart contract includes generating a document based on the smart contract and storing the document in a secure database in association with the voice input.

In one or more embodiments, the voice input includes an acknowledgement to one or more terms of the smart contract.

In one or more embodiments, when obtaining the voice input, the processor-executable instructions, when executed by the at least one processor, further configure the at least one processor to receive, via the communications module and from a client device, the voice input.

In one or more embodiments, prior to receiving the voice input, the processor-executable instructions, when executed by the at least one processor, further configure the at least one processor to send, via the communications module and to the client device, a request for the voice input to trigger execution of the smart contract.

According to another aspect, there is provided a computer-implemented method comprising generating a smart contract that includes at least one precondition associated with voice input; deploying the smart contract on a blockchain network; obtaining the voice input; and communicating an indication of the voice input to the blockchain network to automatically trigger execution of the smart contract.

In one or more embodiments, prior to communicating the indication of the voice input to the blockchain network, the method further comprises engaging a voice recognition module to analyze the voice input to authenticate a user.

In one or more embodiments, when analyzing the voice input to authenticate the user, the method further comprises retrieving, from a database, a voiceprint of the user; and comparing acoustic properties of the voice input to the voiceprint of the user to authenticate the user.

In one or more embodiments, prior to communicating the indication of the voice input to the blockchain network, the method further comprises engaging a natural language processing module to convert the voice input to text; and analyzing the text to confirm that the at least one precondition has been met.

In one or more embodiments, the at least one precondition requires at least one audio file of the voice input and a voice to text translation of the voice input.

In one or more embodiments, the execution of the smart contract includes generating a document based on the smart contract and storing the document in a secure database in association with the voice input.

In one or more embodiments, the voice input includes an acknowledgement to one or more terms of the smart contract.

In one or more embodiments, when obtaining the voice input, the method further comprises receiving, from a client device, the voice input.

In one or more embodiments, prior to receiving the voice input, the method further comprises sending, to the client device, a request for the voice input to trigger execution of the smart contract.

According to another aspect there is provided a non-transitory computer readable storage medium comprising computer-executable instructions which, when executed, configure at least one processor to generate a smart contract that includes at least one precondition associated with voice input; deploy the smart contract on a blockchain network; obtain the voice input; and communicate an indication of the voice input to the blockchain network to automatically trigger execution of the smart contract.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

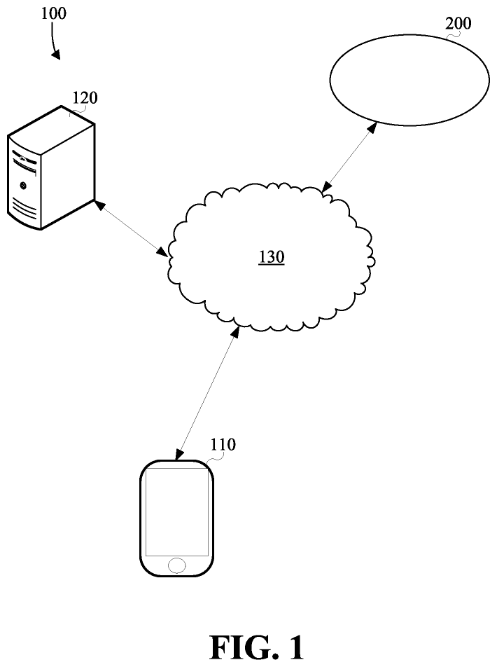

FIG. 1 is a block diagram illustrating an operating environment of an example embodiment. Various components cooperate to provide a system 100 which may be used, for example, to trigger execution of a smart contract. As shown, the system 100 includes a client device 110, a server computer system 120 and a blockchain network 200 coupled to one another through a network 130.

The client device 110 is configured to communicate with the server computer system 120 and the blockchain network 200 via the network 130 and vice-versa. The client device 110 may be remote from the server computer system 120 and the blockchain network 200.

The server computer system 120 is configured to communicate with the blockchain network 200 via the network 130 and vice-versa. The server computer system 120 may be remote from the blockchain network 200.

The client device 110 may be a mobile device as shown in FIG. 1. However, the client device 110 may be a computing device of another type such as for example a laptop computer, a personal computer, a tablet computer, a notebook computer, a hand-held computer, a smart speaker, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The server computer system 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The server computer system 120 may maintain a database that includes data such as for example account data, voice data, etc. The data may be stored in the database in association with an identifier. The identifier may be used to obtain the data.

Data maintained by the server computer system 120 may be associated with authentication information. The authentication information may be or may include any one or more of a token, a username, a password, a personal identification number (PIN), biometric data, etc. The authentication information may be used by the server computer system 120 to authenticate a user and/or a device such as for example the client device 110. For example, the authentication information may be used to determine that the client device 110 is being operated by an authorized user and may be used to identify the user and the data the user is trying to access.

In one or more embodiments, at least some of the data maintained by the server computer system 120 may include a voice print of one or more users. The voice print may be used to authenticate a user and/or a device such as for example the client device 110.

As will be described in more detail below, the server computer system 120 may be configured to generate one or more smart contracts and may perform operations to store the one or more smart contracts on the blockchain network 200.

The server computer system 120 may include a natural language processing (NLP) module that may be engaged to convert voice input to text. The NLP module may utilize techniques such as for example artificial intelligence to convert voice input to text and to understand the text. For example, the NLP module may convert voice to text and the text may be parsed and processed to determine an intent (e.g. command) matching the voice utterance contained in the voice input and one or more parameters for the intent.

The server computer system 120 may include a voice recognition module that may be engaged to identify a user. For example, the voice recognition module may utilize techniques to analyze voice input to identify acoustic properties thereof. The voice recognition module may compare the voice input to one or more voiceprints stored in a database to identify or authenticate the user.

The network 130 is a computer network. The network 130 may include a public network such as the Internet and/or a private network. In some embodiments, the network 130 may be an internetwork such as may be formed of one or more interconnected computer networks. For example, the network 130 may be or may include an Ethernet network, a wireless network, a telecommunications network, or the like.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components.

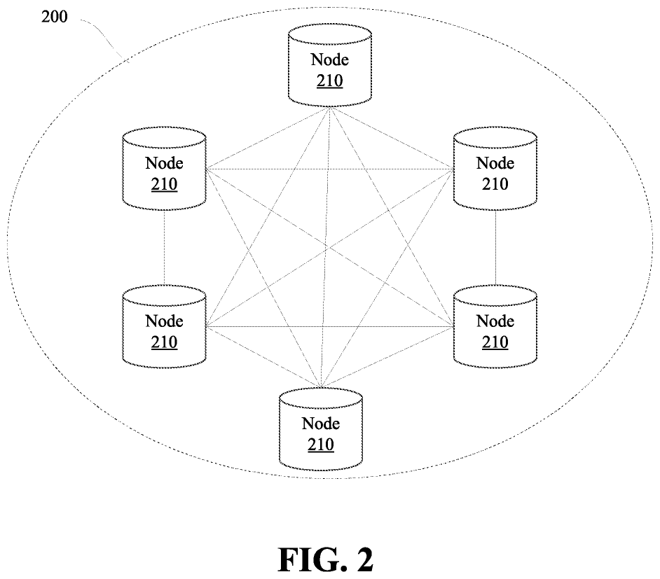

An example of the blockchain network 200 is shown in FIG. 2. The blockchain network 200 may include a peer-to-peer open membership network which may be joined by anyone, without invitation or without consent from other members. Distributed electronic devices running an instance of the blockchain protocol under which the blockchain network 200 operates may participate in the blockchain network 200. Such distributed electronic devices may be referred to as nodes 210. The blockchain protocol may be an Ethereum protocol, or another cryptocurrency, for example.

The electronic devices that run the blockchain protocol and that form the nodes 210 of the blockchain network 200 may be of various types including, for example, computers such as desktop computers, laptop computers, tablet computers, servers, mobile devices such as smartphones, wearable computers such as smart watches or other electronic devices.

Nodes 210 of the blockchain network 200 are coupled to one another using suitable communication technologies which may include wired and wireless communication technologies. In many cases, the blockchain network 200 is implemented at least partly over the Internet, and some of the nodes 210 may be located in geographically dispersed locations.

Nodes 210 maintain a global ledger of all transactions on the blockchain, grouped into blocks, each of which contains a hash of the previous block in the chain. The global ledger is a distributed ledger and each node 210 may store a complete copy or a partial copy of the global ledger. Transactions by a node 210 affecting the global ledger are verified by other nodes 210 so that the validity of the global ledger is maintained. The details of implementing and operating a blockchain network, such as one using the Ethereum protocol, will be appreciated by those ordinarily skilled in the art.

Each transaction typically has one or more inputs and one or more outputs. Scripts embedded into the inputs and outputs specify how and by whom the outputs of the transactions can be accessed. The output of a transaction may be an address to which value (or a digital asset) is transferred as a result of the transaction. That value is then associated with that output address as an unspent transaction output (UTXO). A subsequent transaction may then reference that address as an input in order to spend or disperse that value.

Nodes 210 can fulfill numerous different functions, from network routing to wallet services, to maintain a robust and secure decentralized public ledger. “Full nodes” contain a complete and up-to-date copy of the blockchain, and can therefore verify any transactions (spent or unspent) on the public ledger. “Lightweight nodes” (or SPV) maintain a subset of the blockchain and can verify transactions using a “simplified payment verification” technique. Lightweight nodes only download the headers of blocks, and not the transactions within each block. These nodes therefore rely on peers to verify their transactions. “Mining nodes”, which can be full or lightweight nodes, are responsible for validating transactions and creating new blocks on the blockchain. “Wallet nodes”, which are typically lightweight nodes, handle wallet services of users. Nodes 210 communicate with each other using a connection-oriented protocol, such as TCP/IP (Transmission Control Protocol).

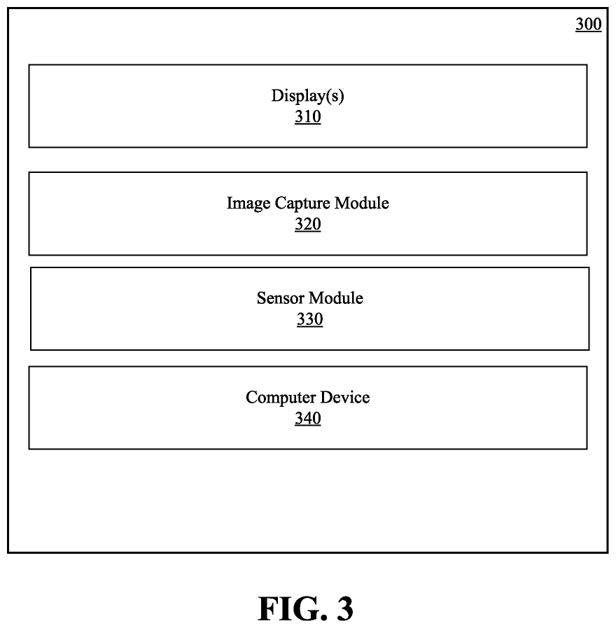

FIG. 3 is a simplified schematic diagram showing components of an exemplary computing device 300. The client device 110 may be of the same type as computing device 300. The computing device 300 may include modules including, as illustrated, for example, one or more displays 310, an image capture module 320, a sensor module 330, and a computer device 340.

The one or more displays 310 are a display module. The one or more displays 310 are used to display screens of a graphical user interface that may be used, for example, to communicate with the server computer system 120 (FIG. 1). The one or more displays 310 may be internal displays of the computing device 300 (e.g., disposed within a body of the computing device).

The image capture module 320 may be or may include a camera. The image capture module 320 may be used to obtain image data, such as images. The image capture module 320 may be or may include a digital image sensor system as, for example, a charge coupled device (CCD) or a complementary metal-oxide-semiconductor (CMOS) image sensor.

The sensor module 330 may be a sensor that generates sensor data based on a sensed condition. By way of example, the sensor module 330 may be or include a location subsystem which generates location data indicating a location of the computing device 300. The location may be the current geographic location of the computing device 300. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The computer device 340 is in communication with the one or more displays 310, the image capture module 320, and the sensor module 330. The computer device 340 may be or may include one or more processors which are coupled to the one or more displays 310, the image capture module 320, and/or the sensor module 330.

The computing device 300 may include additional modules. For example, the computing device 300 may include an I/O module. The I/O module is an input module and an output module. The I/O module may include or may be in communication with a microphone and a speaker. The microphone may include one or more microphones which may, for example, form a microphone array. The microphone may be employed for capturing acoustic signals from the environment proximate the computing device 300. The speaker may include one or more speakers for providing acoustic signals to the environment proximate the computing device 300. In summary, the I/O module may allow the computing device 300 to receive input via a microphone and provide output via a speaker.

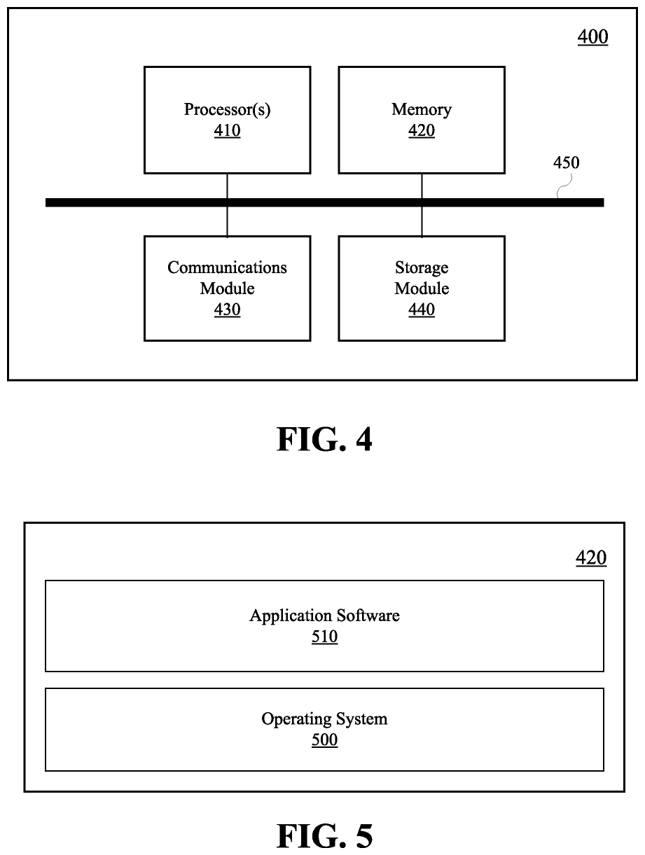

Referring now to FIG. 4, a high-level operation diagram of an example computer device 400 is shown. In some embodiments, the computer device 400 may be exemplary of the computer device 340 (FIG. 3) and/or the server computer system 120.

The example computer device 400 includes a variety of modules. For example, as illustrated, the example computer device 400 may include one or more processors 410, a memory 420, a communications module 430, and/or a storage module 440. As illustrated, the foregoing example modules of the example computer device 400 are in communication over a bus 450.

The one or more processors 410 are hardware processors. The one or more processors 410 may, for example, be one or more ARM, Intel x86, PowerPC processors or the like.

The memory 420 allows data to be stored and retrieved. The memory 420 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computer device 400.

The communications module 430 allows the example computer device 400 to communicate with other computer or computing devices and/or various communications networks. For example, the communications module 430 may allow the example computer device 400 to send or receive communications signals. Communications signals may be sent or received according to one or more protocols or according to one or more standards. For example, the communications module 430 may allow the example computer device 400 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 430 may allow the example computer device 400 to communicate using near-field communication (NFC), via Wi-Fi™, using Bluetooth™ or via some combination of one or more networks or protocols. In some embodiments, all or a portion of the communications module 430 may be integrated into a component of the example computer device 400. For example, the communications module may be integrated into a communications chipset. In some embodiments, the communications module 430 may be omitted such as, for example, if sending and receiving communications is not required in a particular application.

The storage module 440 allows the example computer device 400 to store and retrieve data. In some embodiments, the storage module 440 may be formed as a part of the memory 420 and/or may be used to access all or a portion of the memory 420. Additionally or alternatively, the storage module 440 may be used to store and retrieve data from persisted storage other than the persisted storage (if any) accessible via the memory 420. In some embodiments, the storage module 440 may be used to store and retrieve data in a database. A database may be stored in persisted storage. Additionally or alternatively, the storage module 440 may access data stored remotely such as, for example, as may be accessed using a local area network (LAN), wide area network (WAN), personal area network (PAN), and/or a storage area network (SAN). In some embodiments, the storage module 440 may access data stored remotely using the communications module 430. In some embodiments, the storage module 440 may be omitted and its function may be performed by the memory 420 and/or by the processor 410 in concert with the communications module 430 such as, for example, if data is stored remotely. The storage module may also be referred to as a data store.

Software comprising instructions is executed by the one or more processors 410 from a computer-readable medium. For example, software may be loaded into random-access memory from persistent storage of the memory 420. Additionally or alternatively, instructions may be executed by the one or more processors 410 directly from read-only memory of the memory 420.

FIG. 5 depicts a simplified organization of software components stored in the memory 420 of the example computer device 400 (FIG. 4). As illustrated, these software components include an operating system 500 and an application 510.

The operating system 500 is software. The operating system 500 allows the application 510 to access the one or more processors 410 (FIG. 4), the memory 420, and the communications module 430 of the example computer device 400 (FIG. 4). The operating system 500 may be, for example, Google™ Android™, Apple™ iOS™, UNIX™, Linux™, Microsoft™ Windows™, Apple OSX™ or the like.

The application 510 adapts the example computer device 400, in combination with the operating system 500, to operate as a device performing a particular function. For example, the application 510 may cooperate with the operating system 500 to adapt a suitable embodiment of the example computer device 400 to operate as the computer device 340 (FIG. 3) and/or the server computer system 120.

While a single application 510 is illustrated in FIG. 5, in operation the memory 420 may include more than one application 510 and different applications 510 may perform different operations. For example, in at least some embodiments in which the computer device 400 functions as the client device 110, the applications 510 may include a banking application. The banking application may be configured for secure communications with the server computer system 120 and may provide various banking functions such as, for example, the ability to display a quantum of value in one or more data records (e.g., display balances), configure or request that operations such as transfers of value (e.g., bill payments, email money transfers and other transfers) be performed, and other account management functions.

By way of further example, in at least some embodiments in which the computer device 400 functions as the client device 110, the applications 510 may include a web browser, which may also be referred to as an Internet browser. In at least some such embodiments, the server computer system 120 may be a web server. The web server may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g., display balances), configure or request that operations such as transfers of value (e.g. bill payments and other transfers) be performed, and other account management functions.

The blockchain network 200 utilizes blockchain technology to provide a secure and transparent platform for executing code of one or more smart contracts. Put another way, the blockchain network 200 described herein may store one or more smart contracts.

The smart contracts are self-executing computer programs that automatically enforce the terms of an agreement between parties on the blockchain network 200. When a smart contract is created, it is compiled into bytecode and stored on the blockchain network 200, along with a set of rules that determine how the smart contract will execute. Execution of the smart contract is triggered by one or more preconditions, such as for example the transfer of cryptocurrency or the completion of a specific task. When the one or more preconditions are met, the smart contract automatically executes, performing the predetermined actions and enforcing the terms of the agreement.

The smart contracts are stored on the blockchain network 200 and as such they are immutable and cannot be altered once deployed. Through use of the smart contracts, the parties can trust that the contract will be executed exactly as written, without the risk of human error or interference.

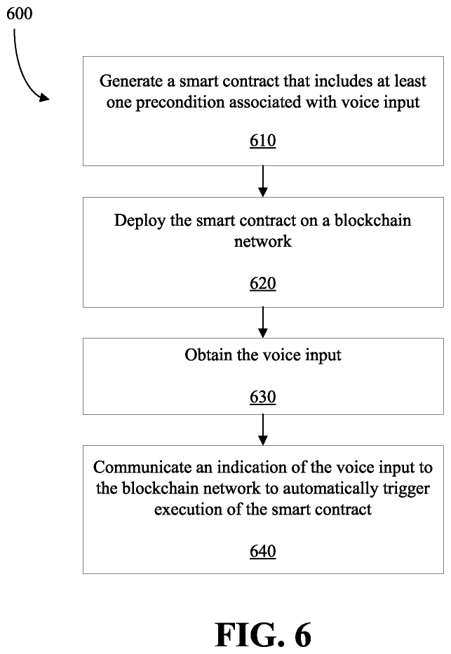

FIG. 6 is a flowchart showing computer operations of a method 600 which may be performed by the server computer system 120 to trigger execution of a smart contract. For example, computer-executable instructions stored in memory of the server computer system 120 may, when executed by one or more processors, configure the server computer system 120 to perform the method 600 or a portion thereof. The server computer system 120 may offload some of the operations to the client device 110 and/or the blockchain network 200.

The method 600 includes generating a smart contract that includes at least one precondition associated with voice input (step 610).

The smart contract is a self-executing computer program that automatically executes terms of a contract or an agreement. The smart contract may automatically execute to enforce terms of an agreement between parties on the blockchain network 200 and/or may automatically execute to perform computations to complete one or more tasks. In one or more embodiments, the parties may include a user operating the client device 110 and a financial institution associated with the server computer system 120. Non-limiting examples include initiating a transfer of resources, opening an account, generating investment contracts, creating buyer/seller agreements, creating home borrowing agreements (e.g., mortgage, home equity), mortgage stipulations, rate lock extensions, consumer/commercial/auto loan agreements, landlord/tenant lease agreements, statement of work, etc.

The smart contract includes at least one precondition. The precondition is a condition that must be met prior to execution of the smart contract. Put another way, the at least one precondition, when met, triggers execution of the smart contract.

The at least one precondition is associated with voice input. In one or more embodiments, the at least one precondition may include a precondition that voice input is received from a particular user. The particular user may include a user that is party to the agreement defined by the smart contract. For example, the smart contract may generate an agreement between the particular user and a financial institution associated with the server computer system 120. The user may include a user operating the client device 110.

In one or more embodiments, the at least one precondition may include a precondition that authentication has been completed using voice input. For example, the authentication may require that the server computer system 120 obtain voice input from a particular user and that the voice input has been used to authenticate the user. In one or more embodiments, authentication of the user may include comparing the voice input to a previously obtained voice print of the user to confirm a match. The previously obtained voice print of the user may have been previously obtained by the server computer system 120 and stored in a database.

In one or more embodiments, the at least one precondition may include a precondition that voice input has been received that includes a particular phrase or indication of acceptance. For example, voice input may be received and the natural language processing (NLP) module may be engaged to convert the voice to text. The text may be analyzed to determine that the particular phrase or indication of acceptance has been received. The indication of acceptance may include an acknowledgement to one or more terms of the smart contract.

In one or more embodiments, the at least one precondition may require at least one audio file of the voice input and a voice to text translation of the input. For example, the at least one precondition may require that at least one audio file be stored in a secure database and may require that voice input obtained from the at least one audio file be converted to text using, for example, the natural language processing module to confirm that the voice input includes a particular phrase or indication of acceptance. The indication of acceptance may include an acknowledgement to one or more terms of the smart contract.

It will be appreciated that additional preconditions may be defined for the smart contract. For example, the additional preconditions may include a transfer of funds, a confirmation of availability of funds, etc. It will be appreciated that all preconditions must be met to trigger execution of the smart contract.

The method 600 includes deploying the smart contract on a blockchain network (step 620).

Responsive to generating the smart contract, the server computer system 120 performs operations to deploy the smart contract on the blockchain network 200. In one or more embodiments, the smart contract may be compiled into bytecode and deployed on the blockchain network 200. The bytecode may include computer object code that an interpreter converts into binary machine code so it can be read by one or more processors. The at least one precondition of the smart contract is also deployed on the blockchain network 200.

To deploy the smart contract on the blockchain network 200, the server computer system 120 may utilize one or more tools such as for example Remix™, Truffle™, or Hardhat™.

The method 600 includes obtaining the voice input (step 630).

In one or more embodiments, the server computer system 120 may obtain the voice input from the client device 110. For example, in one or more embodiments, a user may operate the client device 110 to open a mobile application associated with the server computer system 120. The mobile application may include, for example, a banking application that allows the user to request one or more financial products from a financial institution associated with the server computer system 120. The financial products may include, for example, a mortgage.

Within the mobile application, the server computer system 120 may cause the client device 110 to display a request for the voice input to trigger execution of the smart contract. For example, a graphical user interface may be displayed that includes terms and conditions of an agreement and a message requesting voice input such as for example “Please confirm that you agree to these terms and conditions.”

As another example, where the client device 110 may include a smart speaker, the server computer system 120 may cause the smart speaker to output a message such as for example “The current interest rate offered to you is 5.0%. Please acknowledge that you understand that this rate will be held for you for the next thirty (30) days.”

In one or more embodiments, the server computer system 120 may obtain the voice input from a database. For example, voice input may have been previously obtained and stored in the voice input and the server computer system 120 may perform operations to retrieve the voice input from the database.

The method 600 includes communicating an indication of the voice input to the blockchain network to automatically trigger execution of the smart contract (step 640).

In one or more embodiments, the server computer system 120 may analyze the voice input. For example, prior to communicating the indication of the voice input to the blockchain network, the server computer system 120 may engage the voice recognition module to authenticate the user. Specifically, the voice recognition module may utilize techniques to analyze the voice input to identify acoustic properties thereof. The acoustic properties may include the voice, tone, pitch, cadence and other speech patterns. The acoustic properties may be measured and compared to a database of previously obtained voiceprints to determine if there is a match and this may be done to authenticate a user. Additionally or alternatively, the server computer system 120 may retrieve, from the database, a known voiceprint of the user and this may be identified using, for example, authentication information of the user such as for example a username or account number of the user. The acoustic properties of the voice input may be compared to the voiceprint of the user to authenticate the user.

As another example, prior to communicating the indication of the voice input to the blockchain network, the server computer system 120 may engage the natural language processing module to convert the voice input to text. The server computer system 120 may analyze the text to confirm that the at least one precondition of the smart contract has been met. Specifically, the text may be analyzed to determine that a particular phrase or indication of acceptance has been received.

The indication of the voice input may be sent to the blockchain network 200 as a binary message that indicates that the at least one precondition has been met. For example, the server computer system 120 may analyze the voice input to determine that the at least one precondition associated with voice input has been met and may send a binary message indicating that the at least one precondition has been met.

In one or more embodiments, the indication of the voice input may include the voice input and the blockchain network 200 may itself perform one or more operations to determine that the at least one precondition has been met. For example, the blockchain network 200 may perform operations similar to one or more of those described above to determine that the at least one precondition has been met.

When it has been determined that the at least one precondition associated with voice input has been met, the execution of the smart contract is automatically triggered. In one or more embodiments, execution of the smart contract may include generating a document or agreement based on the smart contract and storing the document in a secure database. In one or more embodiments, the blockchain network 200 may be updated to include the document or agreement. In one or more embodiments, the document or agreement may be communicated to the server computer system 120 where the server computer system 120 may store the document or agreement in the database.

The above-described methods and systems may be implemented in ambient computing environments where a smart speaker such as the Amazon™ Echo™ smart speaker and the Google™ Home™ smart speaker may be utilized to satisfy preconditions to trigger execution of one or more smart contracts.

For example, in one or more embodiments, the system 100 may include a smart speaker and a user may operate the smart speaker to enable a banking application plug-in module that allows the server computer system 120 to communicate with the smart speaker. For example, the user may submit input in the form of a voice utterance requesting that the plug-in be enabled. In examples where the smart speaker is an Amazon Echo, the user may say “Hey Alexa, enable The Banking Application.”

Once enabled, the server computer system 120 may communicate with the smart speaker to obtain voice input that may be used to satisfy one or more preconditions of a smart contract and to automatically trigger execution of the smart contract, in manners similar to that described herein. Prior to obtaining the voice input, the server computer system 120 may communicate with the smart speaker to request the voice input to trigger execution of the smart contract, in manners similar to that described herein.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A system comprising:
a communications module;
at least one processor coupled to the communications module; and
a memory coupled to the at least one processor, the memory storing processor-executable instructions which, when executed by the at least one processor, configure the at least one processor to:
generate a smart contract that includes at least one precondition associated with voice input;
deploy the smart contract on a blockchain network;
obtain the voice input; and
communicate an indication of the voice input to the blockchain network to automatically trigger execution of the smart contract.

2. The system of claim 1, wherein prior to communicating the indication of the voice input to the blockchain network, the processor-executable instructions, when executed by the at least one processor, configure the at least one processor to:
engage a voice recognition module to analyze the voice input to authenticate a user.

3. The system of claim 2, wherein when analyzing the voice input to authenticate the user, the processor-executable instructions, when executed by the at least one processor, configure the at least one processor to:
retrieve, from a database, a voiceprint of the user; and
compare acoustic properties of the voice input to the voiceprint of the user to authenticate the user.

4. The system of claim 1, wherein prior to communicating the indication of the voice input to the blockchain network, the processor-executable instructions, when executed by the at least one processor, configure the at least one processor to:
engage a natural language processing module to convert the voice input to text; and
analyze the text to confirm that the at least one precondition has been met.

5. The system of claim 1, wherein the at least one precondition requires voice input from a particular user.

6. The system of claim 1, wherein the at least one precondition requires at least one audio file of the voice input and a voice to text translation of the voice input.

7. The system of claim 1, wherein the execution of the smart contract includes generating a document based on the smart contract and storing the document in a secure database in association with the voice input.

8. The system of claim 1, wherein the voice input includes an acknowledgement to one or more terms of the smart contract.

9. The system of claim 1, wherein when obtaining the voice input, the processor-executable instructions, when executed by the at least one processor, further configure the at least one processor to:
receive, via the communications module and from a client device, the voice input.

10. The system of claim 9, wherein prior to receiving the voice input, the processor-executable instructions, when executed by the at least one processor, further configure the at least one processor to:
send, via the communications module and to the client device, a request for the voice input to trigger execution of the smart contract.

11. A computer-implemented method comprising:
generating a smart contract that includes at least one precondition associated with voice input;
deploying the smart contract on a blockchain network;
obtaining the voice input; and
communicating an indication of the voice input to the blockchain network to automatically trigger execution of the smart contract.

12. The computer-implemented method of claim 11, wherein prior to communicating the indication of the voice input to the blockchain network, the method further comprises:
engaging a voice recognition module to analyze the voice input to authenticate a user.

13. The computer-implemented method of claim 12, wherein when analyzing the voice input to authenticate the user, the method further comprises:
retrieving, from a database, a voiceprint of the user; and
comparing acoustic properties of the voice input to the voiceprint of the user to authenticate the user.

14. The computer-implemented method of claim 11, wherein prior to communicating the indication of the voice input to the blockchain network, the method further comprises:
engaging a natural language processing module to convert the voice input to text; and
analyzing the text to confirm that the at least one precondition has been met.

15. The computer-implemented method of claim 11, wherein the at least one precondition requires at least one audio file of the voice input and a voice to text translation of the voice input.

16. The computer-implemented method of claim 11, wherein the execution of the smart contract includes generating a document based on the smart contract and storing the document in a secure database in association with the voice input.

17. The computer-implemented method of claim 11, wherein the voice input includes an acknowledgement to one or more terms of the smart contract.

18. The computer-implemented method of claim 11, wherein when obtaining the voice input, the method further comprises:
receiving, from a client device, the voice input.

19. The computer-implemented method of claim 18, wherein prior to receiving the voice input, the method further comprises:
sending, to the client device, a request for the voice input to trigger execution of the smart contract.

20. A non-transitory computer readable storage medium comprising computer-executable instructions which, when executed, configure at least one processor to:
generate a smart contract that includes at least one precondition associated with voice input;
deploy the smart contract on a blockchain network;
obtain the voice input; and
communicate an indication of the voice input to the blockchain network to automatically trigger execution of the smart contract.
